(19) United States
(12) Patent Application Publication
(10) Pub. No.: US 2016/0368664 A1
(43) Pub. Date: Dec. 22, 2016

(54) Collapsible Container

(71) Applicants: Marichu Balmes, Amarillo, TX (US); Kimarie Balmes, Amarillo, TX (US)

(72) Inventors: Marichu Balmes, Amarillo, TX (US); Kimarie Balmes, Amarillo, TX (US)

(21) Appl. No.: 15/184,672

(22) Filed: Jun. 16, 2016

Related U.S. Application Data
(60) Provisional application No. 62/180,378, filed on Jun. 16, 2015.

(51) Int. Cl. B65D 21/08; F16B 47/00; F16M 13/02; B65D 25/28

(52) U.S. Cl. CPC B65D 21/086; B65D 25/28; F16B 47/00; F16M 13/022

(57) ABSTRACT

A collapsible container. The present container includes a foldable wall extending between a rim and a base, wherein the rim defines an opening. The foldable wall includes a plurality of wall sections, each of the plurality of wall sections movable between an extended configuration and a collapsed configuration wherein the plurality of wall sections are concentric and laterally aligned with each other. The container further includes a handle pivotably attached to the rim via a hinge, wherein the handle is movable between a folded configuration and an extended configuration.

### CROSS REFERENCE TO RELATED APPLICATIONS

This application claims the benefit of U.S. Provisional Application No. 62/180,378 filed on Jun. 16, 2015. The above identified patent application is herein incorporated by reference in its entirety to provide continuity of disclosure.

### BACKGROUND OF THE INVENTION

The present invention relates to containers. More specifically, the present invention relates to collapsible containers that are securable to surfaces for support.

Collapsible containers are generally known in the art. However, such containers can be easily knocked over, spilling the contents therein, when the container or the surface on which the container is resting is inadvertently jostled or contacted. Furthermore, collapsible containers either lack a handle, which reduces the overall utility of the container, or have a handle that is not foldable, restricting the degree of compactness that can be achieved by the collapsible container. In light of the above, there is a need in the prior art for a collapsible container that includes both a mount for supporting the container in a vertical orientation and a foldable handle.

### SUMMARY OF THE INVENTION

In view of the foregoing disadvantages inherent in the known types of collapsible containers now present in the prior art, the present invention provides a collapsible container having a support mount, e.g. a suction cup, disposed on a bottom surface thereof wherein the same can be utilized for providing convenience for the user. The present container includes a foldable wall extending between a rim and a base, wherein the rim defines an opening. The foldable wall includes a plurality of wall sections, each of the plurality of wall sections movable between an extended configuration and a collapsed configuration wherein the plurality of wall sections are concentric and laterally aligned with each other. The container further includes a handle pivotably attached to the rim via a hinge, wherein the handle is movable between a folded configuration and an extended configuration.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the collapsible container in an expanded configuration.

FIG. 2 shows a perspective view of the collapsible container in a collapsed configuration.

FIG. 3 shows a view of the bottom surface of the collapsible container.

### DETAILED DESCRIPTION OF THE INVENTION

Reference is made herein to the attached drawings. Like reference numerals are used throughout the drawings to depict like or similar elements of the collapsible container. The figures are intended for representative purposes only and should not be considered to be limiting in any respect.

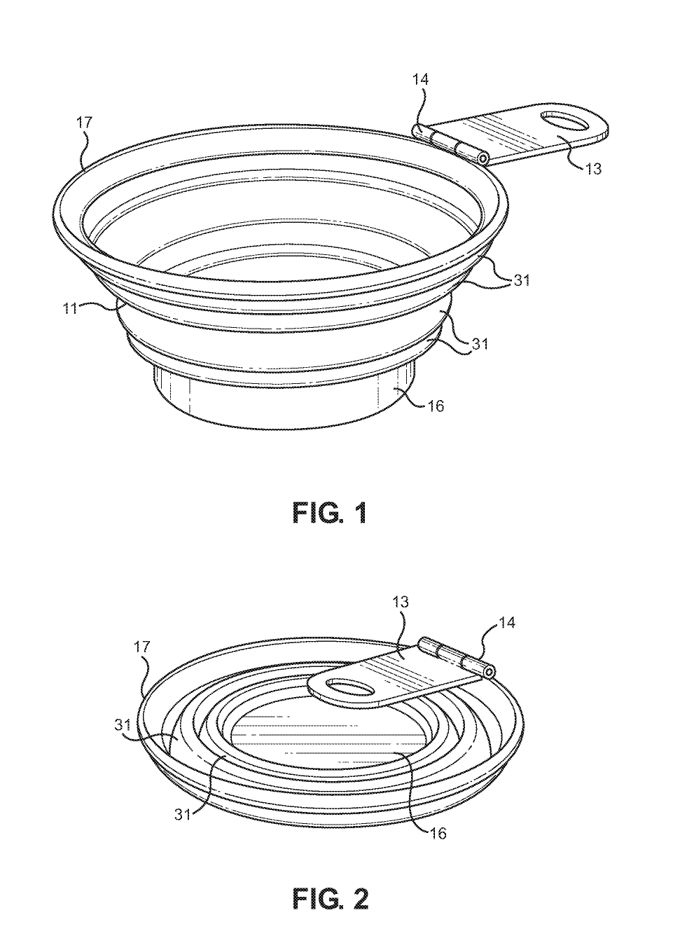

Referring now to FIGS. 1 and 2, there are shown perspective views of the collapsible container in an expanded configuration and a collapsed configuration. The present container includes a foldable wall 11 extending between a base 16 and a rim 17. The base 16 is a rigid, closed geometric shape that can be planar, convex, or concave. The rim 17 defines an opening through which the interior volume of the container can be accessed. The foldable wall 11, rim 17, and base 16 are bonded, joined, or otherwise constructed to form a unitary or monolithic structure, such as via an injection molding procedure. The foldable wall 11 has a generally frustoconical shape with a ribbed or undulating surface and includes one or more wall sections 31.

The wall sections 31 are annular segments of decreasing diameter from the rim 17 to the base 16 to form an inclined surface. Each wall section 31 is divided into a rigid sub-section and a sub-section that provides flexure, thereby allowing the base 16 and wall sections 31 to collapse into the wall section 31 immediately superior thereto. The flexure is provided by the sub-section being thinner that the rigid sub-section and/or being constructed from a material having less rigidity than the material from which the rigid sub-section is constructed. As the present container is collapsed, as depicted in FIG. 2, the wall sections 31 are arranged concentrically and are laterally aligned in order to greatly reduce the overall profile of the container and make it more compact. In addition to the present container being transitionable between the collapsed configuration in which all of the wall sections 31 are collapsed and the extended configuration in which all of the wall sections 31 are extended, the wall sections 31 have sufficient rigidity such that the present container can be transitioned to any intermediate position therebetween in which any number of the wall sections 31 are collapsed or extended.

The present container further includes a handle 13 that is pivotably attached to the rim 17 via a hinge 14. In the depicted embodiment of the present container, the handle 13 comprises a planar member having an aperture disposed at a distal end thereof. The handle 13 is configured to transition from a folded position and an extended position. In the folded position, the handle 13 extends generally perpendicularly from the rim 17, towards the center point of the opening defined by the rim 17. When the present container is in its collapsed configuration, the handle 13 is configured to rest across the edges of the collapsed wall sections 31. In the extended position, the handle 13 extends generally perpendicularly from the rim 17, away from the center point of the opening defined by the rim 17. In one embodiment of the present container, the hinge 14 has a 180-degree range of motion, restricting the movement of the handle 13 from extending beyond the position wherein the handle 13 is perpendicular relative to the rim 17 of the container.

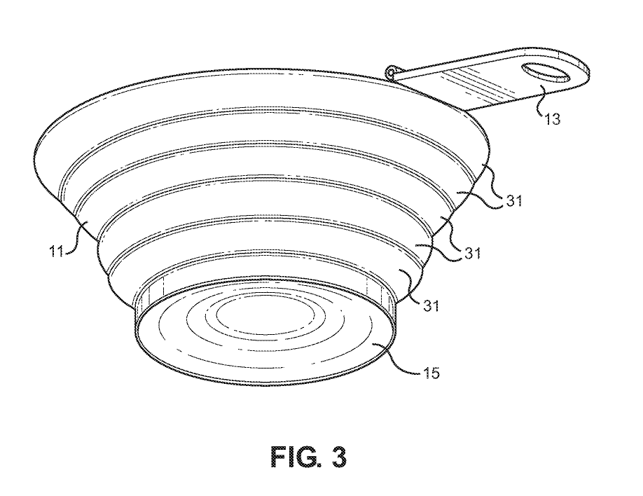

Referring now to FIG. 3, there is shown a view of the bottom surface of the collapsible container. The present container further comprises a support mount 15 disposed on an undersurface of the base. In the depicted embodiment of the present container, the support mount 15 is a suction cup. The support mount 15 is configured to secure the present container in a vertical orientation against a support surface, e.g. a countertop or a table, when the container is in its extended configuration. The support mount 15 prevents the container from being knocked over when the container or the support surface on which the container is resting is inadvertently jostled or otherwise contacted. In the depicted embodiment of the present container, the entirety of the base is occupied by the suction cup disposed thereon.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A collapsible container, comprising:
a foldable wall extending between a rim and a base;
the rim defining an opening;
the foldable wall including a plurality of wall sections, each of the plurality of wall sections movable between an extended configuration and a collapsed configuration wherein the plurality of wall sections are concentric and laterally aligned with each other;
a handle pivotably attached to the rim via a hinge, the handle movable between a folded configuration and an extended configuration, wherein the folded configuration is perpendicular to the rim and directed towards a center point of the opening and the extended configuration is perpendicular to the rim and directed away from the center point of the opening; and
a suction cup disposed on a bottom surface of the base.

2) The collapsible container of claim 1, wherein the foldable wall, the rim, and the base are constructed to form a unitary structure.

3) The collapsible container of claim 1, wherein each of the plurality of wall sections comprises a rigid sub-section and a flexible sub-section.

4) The collapsible container of claim 3, wherein the flexible sub-section is thinner than the flexible sub-section.

5) The collapsible container of claim 3, wherein the flexible sub-section is constructed from a less rigid material than a material from which the rigid sub-section is constructed.

6) The collapsible container of claim 1, wherein the collapsible container is transitionable between a first position wherein all of the plurality of wall sections are extended, a second position wherein all of plurality of wall sections are collapsed, and any intermediate position therebetween wherein both one or more of the plurality of wall sections are extended and one or more of the plurality of wall sections are collapsed.
